(19) United States
(12) Patent Application Publication
(10) Pub. No.: US 2019/0264767 A1
(43) Pub. Date: Aug. 29, 2019

(54) LAWN CARE VEHICLE

(71) Applicant: MTD PRODUCTS INC, Valley City, OH (US)

(72) Inventor: Michael Miller, Valley City, OH (US)

(21) Appl. No.: 16/222,102

(22) Filed: Dec. 17, 2018

Related U.S. Application Data
(63) Continuation of application No. 15/265,803, filed on Sep. 14, 2016, now abandoned.
(60) Provisional application No. 62/218,551, filed on Sep. 14, 2015.

(51) Int. Cl. F16F 1/12; B62D 25/10; F01N 1/00; F01N 13/00; A01D 34/64; B62D 21/02; A01D 34/66

(52) U.S. Cl. CPC F16F 1/125; B62D 25/10; F01N 1/00; F01N 13/002; F01N 2590/00; B62D 21/02; A01D 34/667; A01D 34/661; A01D 34/64

(57) ABSTRACT

The disclosed technology relates to features provided on a lawn care vehicle. One of the features relates a spring tension assembly incorporated into a deck lift assembly. The spring tension assembly includes a spring body having a plurality of coils along a longitudinal axis between a first end and a second end. The second end of the spring body is configured to define a female threaded portion, which is threadedly engaged by a threaded fastener. Another feature relates to a lawn care vehicle hood assembly that can be assembled in a substantially tool-less manner. Another feature relates to a muffler assembly including a muffler body and a muffler shield assembly having a first wall positioned adjacent a first side of the muffler body and a second wall positioned adjacent a second side of the muffler body.

### CROSS-REFERENCE TO RELATED APPLICATIONS

This application is a continuation of U.S. Non-Provisional patent application Ser. No. 15/265,803 filed Sep. 14, 2016 which claims benefit of U.S. Provisional Patent Application Ser. No. 62/218,551, filed Sep. 14, 2015, and entitled “LAWN CARE VEHICLE,” which is herein incorporated by reference in its entirety.

### FIELD OF THE INVENTION

The disclosed technology relates generally to outdoor power equipment, and, more particularly, to a lawn care vehicle (e.g., a riding mower or a lawn and garden tractor).

### BACKGROUND OF THE INVENTION

Lawn care vehicles, such as riding lawn mowers and lawn and garden tractors are made up of a number of systems and components. The systems and components include cutting decks having one or more blades that are driven to spin and cut grass. Many riding lawn mowers include deck lift assemblies, where the user can raise and lower the cutting deck, typically using a lever or pedal.

Many lawn care vehicles include engines housed or otherwise supported near the front of the machine and covered by a hood assembly. The hood assembly often is pivotally attached to a frame such that the hood assembly can be rotated for access to the engine. The lawn care vehicle typically includes an exhaust system coupled to the engine, and including a muffler assembly.

### BRIEF SUMMARY

Aspects of the disclosed technology relate to features implemented on a lawn care vehicle (e.g., a riding mower or a lawn and garden tractor).

One aspect of the disclosed technology relates to a spring tension assembly that includes a spring body having a plurality of coils along a longitudinal axis between a first end and a second end; a first attachment mechanism coupled to or included with the first end; and wherein the second end is configured to include a female threaded portion.

According to one feature, a plurality of coils at the second end define a female threaded portion.

According to one feature, the spring tension assembly includes a threaded fastener configured to threadedly engage the female threaded portion of the second end.

According to one feature, the spring body has a first diameter and the second end has a second diameter that is smaller than the first diameter.

According to one feature, the spring body has a pitch that is equal to the pitch of the second end.

According to one feature, the first attachment mechanism is a hook portion.

According to one feature, the spring body is formed of coiled metal and the hook portion is integrally formed from the coiled metal.

According to one feature, the second end defines a female threaded connection having a pitch, wherein the pitch matches the pitch of the threaded fastener.

Another aspect of the disclosed technology relates to a method of installing a tension spring. The method includes positioning a spring tension assembly between two members to be coupled, the spring tension assembly including a spring body having a plurality of coils along a longitudinal axis between a first end and a second end, wherein a first attachment mechanism is coupled to or included with the first end, and wherein the second end is configured to include a female threaded portion; coupling the first attachment mechanism to the first member to be coupled; positioning the second end of the spring tension assembly proximate the second member to be coupled such that the second end of the spring tension assembly is proximate an aperture in the second member to be coupled; introducing a male threaded member through the aperture in the second member and into the female threaded portion of the spring tension assembly; and rotating the male threaded member in a direction that draws the second end of the spring body toward the second member and extends the spring to a desired tension.

Another aspect of the disclosed technology relates to a method of installing a deck lift assembly to couple a mower deck to an associated mower frame. The method includes positioning a lift-assist tension spring assembly between two members to be coupled, the lift-assist tension spring assembly including a spring body having a plurality of coils along a longitudinal axis between with a first end and a second end, wherein a first attachment mechanism is coupled to or included with the first end, and wherein the second end is configured to include a female threaded portion; connecting a first end of lift-assist tension spring assembly to a portion of the deck lift assembly; positioning the second end of the spring body proximate to a portion of the mower frame such that the second end of the spring tension assembly is proximate an aperture in the mower frame; introducing a threaded fastener through the aperture in the second member and into the female threaded portion of the spring tension assembly; and rotating the threaded fastener in a first direction such that it extends the spring and places the spring under tension to provide a biasing force between the frame and the deck lift assembly.

Another aspect of the disclosed technology relates to a lawn care vehicle hood assembly that includes a hood frame portion; a grill portion; a pair of side portions; and a top portion; wherein the hood frame portion and the grill portion are configured to slide and lock into engagement.

According to one feature, the side portions are configured to slide and hook into engagement with the grill portion and the hood frame portion.

According to one feature, the top portion is configured to slide and lock into engagement with an upper portion of the hood frame portion.

According to one feature, the top portion is configured to engage the top of the hood frame portion by way of receiving slots positioned on an underside of the top portion.

Another aspect of the disclosed technology relates to a method of assembling a lawn care vehicle hood assembly. The method includes providing an upper portion having a plurality of slide lock features; positioning a grill portion adjacent the upper portion, the grill portion having a plurality of slide lock features configured to engage the slide lock features of the upper portion; sliding the upper portion relative to the grill portion such that the respective slide lock features of the upper portion and the grill portion engage.

According to one feature, the method includes positioning a pair of side portions adjacent the engaged upper portion and grill portion, the side portions including hook members configured to engage receiving members associated with the grill portion and/or the upper portion; and engaging the side portions to the engaged grill portion and upper portion.

According to one feature, the method includes positioning a top portion adjacent the upper portion, the top portion including a plurality of receiving slots configured to slidingly engage slide lock members associated with the upper portion; and sliding the top porting relative to the upper portion such that the slide lock members associated with the upper portion engage the receiving slots associated with the top portion.

Another aspect of the disclosed technology relates to a muffler assembly for a lawn care vehicle, the muffler assembly including a muffler body having at least a first exhaust input; a muffler shield assembly positioned adjacent the muffler body, the muffler shield assembly having a first wall positioned adjacent a first side of the muffler body and a second wall positioned adjacent a second side of the muffler body.

According to one feature, the first wall is positioned adjacent a first side of the muffler body and the second wall is positioned adjacent a second side of the muffler body opposite the first side of the muffler body.

According to one feature, the first wall is an upper wall and disposed above the muffler body and the second wall is a lower wall disposed below the muffler body.

According to one feature, the upper wall and lower wall are coupled by a vent wall defining a plurality of vent openings.

According to one feature, the muffler assembly is positioned to receive airflow between the first wall and the second wall.

Features of the disclosed technology will be apparent with reference to the following description and attached drawings. In the description and drawings, particular embodiments or aspects of the disclosed technology have been disclosed in detail as being indicative of some of the ways in which the principles of the disclosed technology may be employed, but it is understood that the disclosed technology is not limited correspondingly in scope. Rather, the disclosed technology includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF SEVERAL VIEWS OF THE DRAWINGS

These and other features of the disclosed technology, and their advantages, are illustrated specifically in embodiments of the disclosed technology now to be described, by way of example, with reference to the accompanying diagrammatic drawings, in which:

FIG. 1 is a front perspective view of a lawn care vehicle in accordance with one exemplary aspect of the disclosed technology;

FIG. 2 is a top view of the exemplary lawn care vehicle of FIG. 1;

FIG. 3 is a right side view of the exemplary lawn care vehicle of FIG. 1;

FIG. 4 is a front view of the exemplary lawn care vehicle of FIG. 1;

FIG. 5 is a left side view of the exemplary lawn care vehicle of FIG. 1;

FIG. 6 is a rear perspective view of the exemplary lawn care vehicle of FIG. 1;

FIG. 7 is a rear view of the exemplary lawn care vehicle of FIG. 1;

FIG. 8 is a bottom view of the exemplary lawn care vehicle of FIG. 1;

FIG. 9 is a view of a spring tension assembly in accordance with one aspect of the disclosed technology;

FIG. 10 is an exploded view of the spring tension assembly of FIG. 9;

FIG. 11 is another view of the spring tension assembly of FIG. 9;

FIG. 12 is a diagrammatic illustration of a spring tension assembly configured as a lift-assist spring in conjunction with a deck lift in accordance with one aspect of the disclosed technology;

FIG. 13 is a diagrammatic illustration of a spring tension assembly configured as a lift-assist spring in conjunction with a deck lift in accordance with one aspect of the disclosed technology;

FIG. 14 is a perspective view of a hood assembly in accordance with one exemplary aspect of the disclosed technology;

FIG. 15 is an exploded view of the hood assembly of FIG. 14;

FIG. 16 is a perspective view of a portion of the hood assembly of FIG. 14;

FIG. 17 is a perspective view of a portion of the hood assembly of FIG. 14;

FIG. 18 is a partially exploded view of the hood assembly of FIG. 14;

FIG. 19 is a bottom view of an exemplary top portion of the hood assembly of FIG. 14;

FIG. 20 is a partially exploded view of a muffler assembly in accordance with one exemplary aspect of the disclosed technology;

FIG. 21 is a partially exploded view of a muffler assembly in accordance with one exemplary aspect of the disclosed technology;

FIG. 22 shows views of a muffler assembly in accordance with one exemplary aspect of the disclosed technology;

FIG. 23 shows a view of a muffler assembly in accordance with one exemplary aspect of the disclosed technology;

FIG. 24 is a diagrammatic illustration of an exemplary discharge assembly in accordance with one aspect of the disclosed technology;

FIG. 25 is a diagrammatic illustration of an exemplary discharge assembly in accordance with one aspect of the disclosed technology;

FIG. 26 is a diagrammatic illustration of an exemplary discharge chute deflector in accordance with one aspect of the disclosed technology;

FIG. 27 is a diagrammatic illustration of an exemplary power takeoff (PTO) control lever and control lever support assembly in accordance with one aspect of the disclosed technology;

FIG. 28 is a diagrammatic illustration of an exemplary control lever support assembly coupled to an exemplary control lever in accordance with one aspect of the disclosed technology;

FIG. 29 is a diagrammatic illustration of an exemplary control lever support assembly in a closed configuration in accordance with one aspect of the disclosed technology;

FIG. 30 is a diagrammatic illustration of an exemplary control lever support assembly in an open configuration in accordance with one aspect of the disclosed technology;

FIG. 31 is a partially exploded view of an electric power takeoff (PTO) clutch and a vibration isolation mount for an associated anti-rotation bracket in accordance with one aspect of the disclosed technology;

FIG. 32 is an assembled view of an electric power takeoff (PTO) clutch and a vibration isolation mount for an associated anti-rotation bracket in accordance with one aspect of the disclosed technology.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION OF EMBODIMENTS

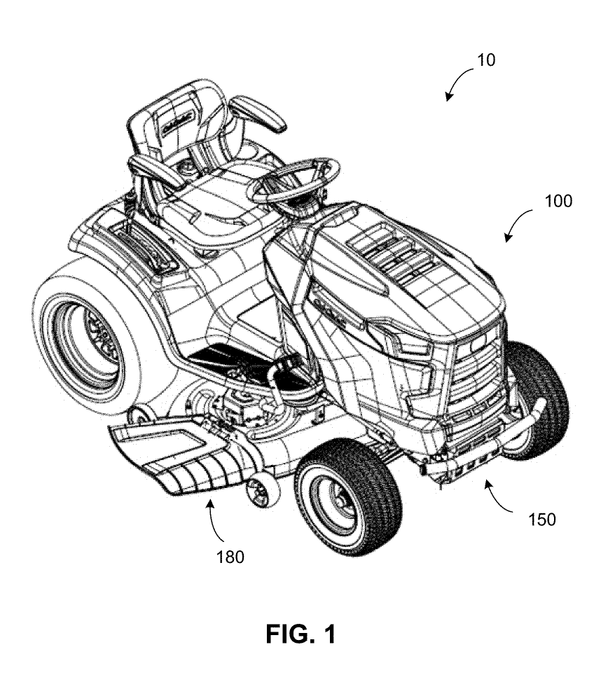

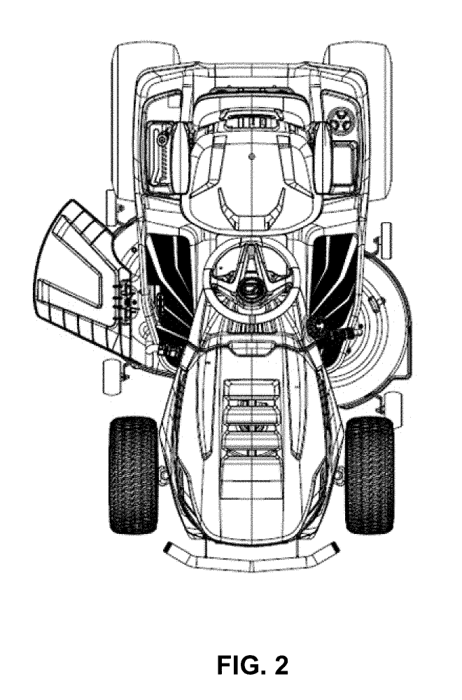

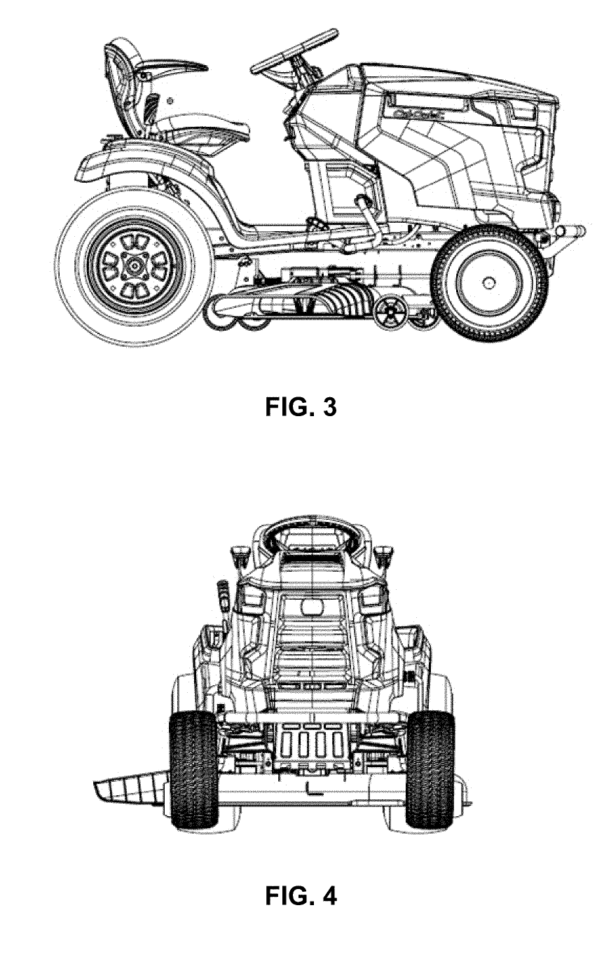

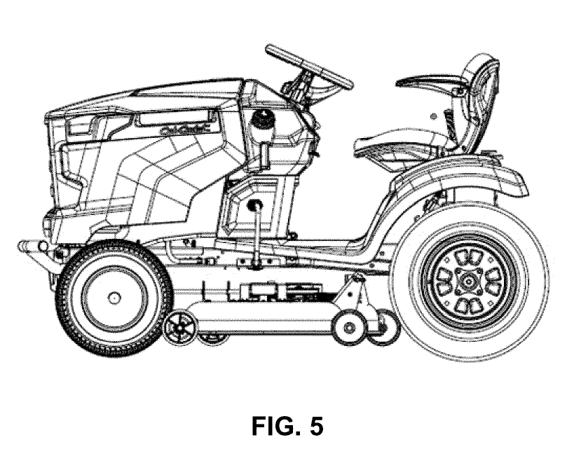

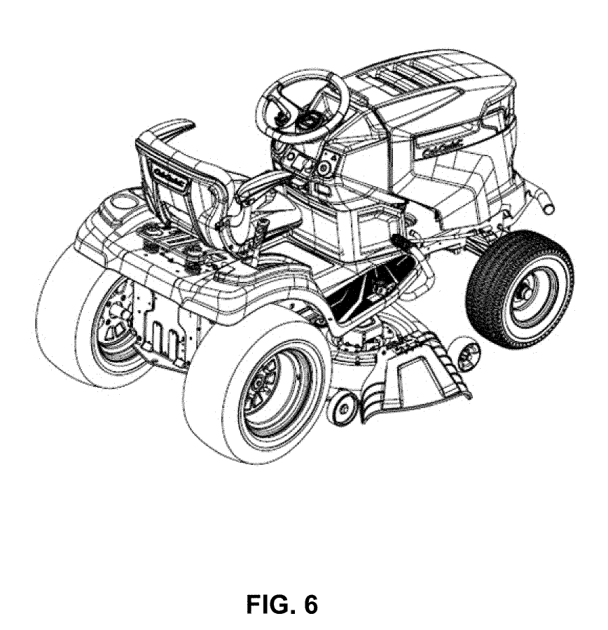

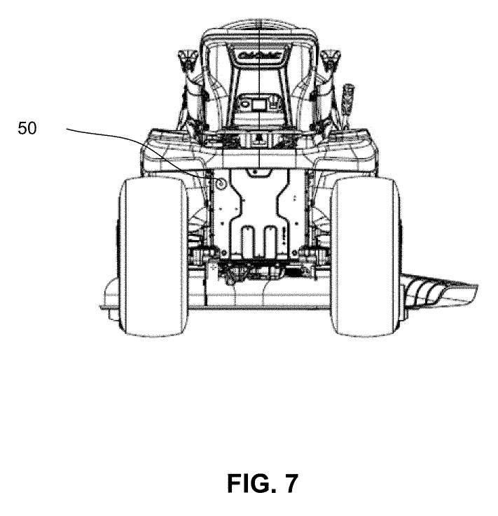

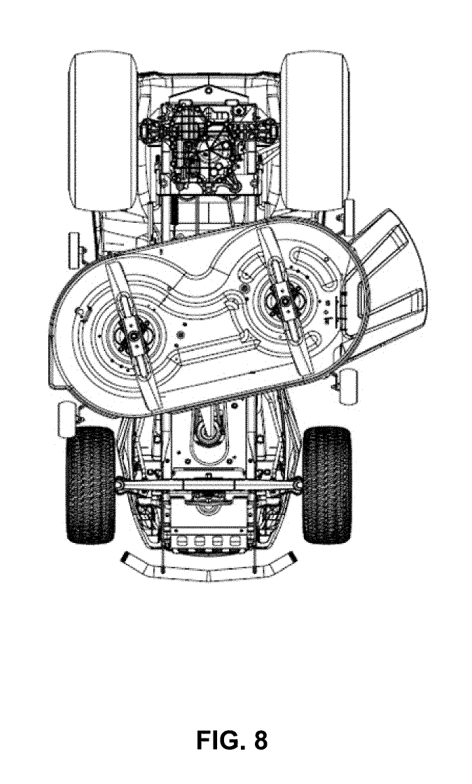

FIGS. 1-8 show views of a lawn care vehicle 10 (e.g., a riding lawn mower or lawn and garden tractor) in accordance with one exemplary aspect of the disclosed technology. Aspects of the disclosed technology, including, but not limited to, the adjustable spring-tension assembly 50, the deck lift system, the multi-piece hood assembly 100, the muffler assembly 150, and the discharge chute attachment mechanism 180 will be described in connection with the exemplary lawn care vehicle illustrated in FIGS. 1-8. It will be appreciated, however, that these aspects of the disclosed technology may be used in connection with other applications or environments without departing from the scope of the disclosed technology.

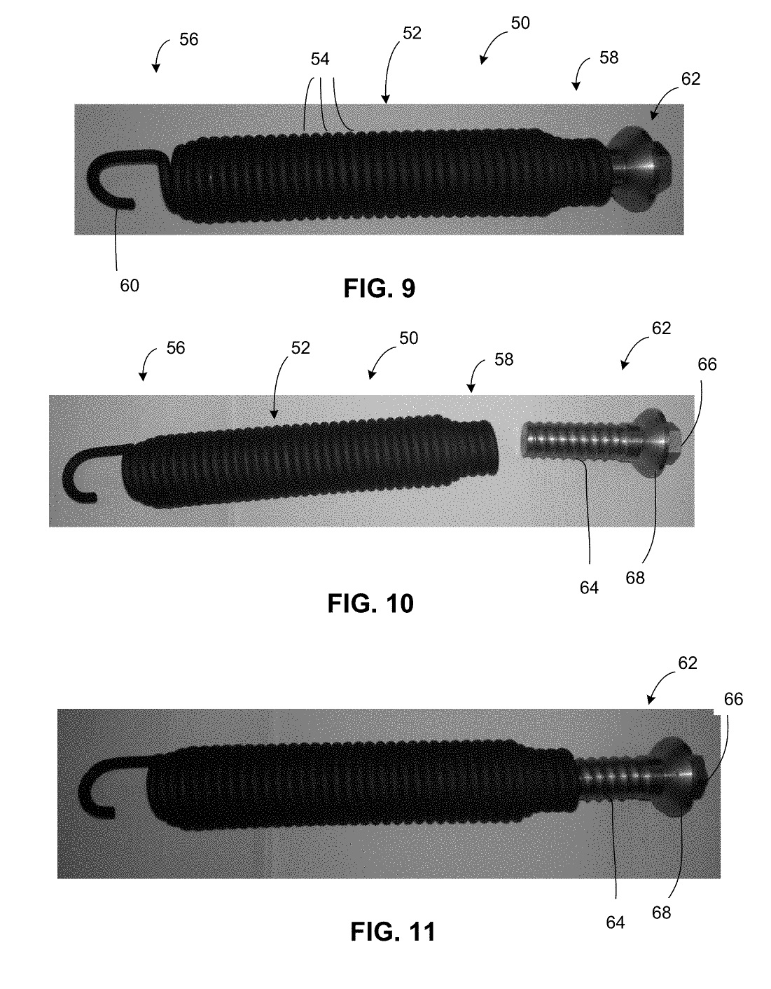

One aspect of the disclosed technology relates to spring tension assembly, (e.g., a lift-assist spring assembly to be coupled between a deck lift assembly and a portion of the vehicle frame). Exemplary embodiments are illustrated in FIGS. 9-13.

As shown in FIGS. 9-11, the spring-tension assembly 50 includes a spring body 52 having a plurality of coils 54 along a longitudinal axis between a first end 56 and a second end 58. As will be described more fully below in connection with an exemplary embodiment, the first end 56 can be configured to couple to a first structure, such as a deck lift system and the second end 58 can be configured to include a threaded internal portion configured to couple to a second structure, such as a frame portion.

In the illustrated exemplary embodiment of FIGS. 9-11, the spring body 52 is configured to include a first attachment mechanism 60 in the form of a hook portion integrally formed of the coiled metal that makes up the spring body 52. The second end 58 of the spring body is configured to include otherwise define a female threaded portion made from the coils of the spring body at the second end. In the illustrated exemplary embodiment, the coils at the second end, which are configured to form or otherwise define a female threaded portion have a smaller diameter than the coils in the remainder of the spring body.

The spring tension assembly 50 includes a threaded fastener element 62 configured to threadedly engage the female threaded portion of the second end 58 of the spring body 52. The fastener element 62 includes a threaded portion 64 having a pitch that matches or substantially corresponds to the pitch of the female threaded portion in the second end 58 of the spring body 52. In operation, the fastener element 62 can be rotated to advance the fastener into the threaded end of the spring body to extend or otherwise tension the spring.

As can be seen in FIG. 10, the fastener 62 includes a head portion 66 and a collar portion 68. The collar portion is curved to facilitate rotation of the fastener when the collar is engaging an anchor member (e.g., the frame portion described more fully below).

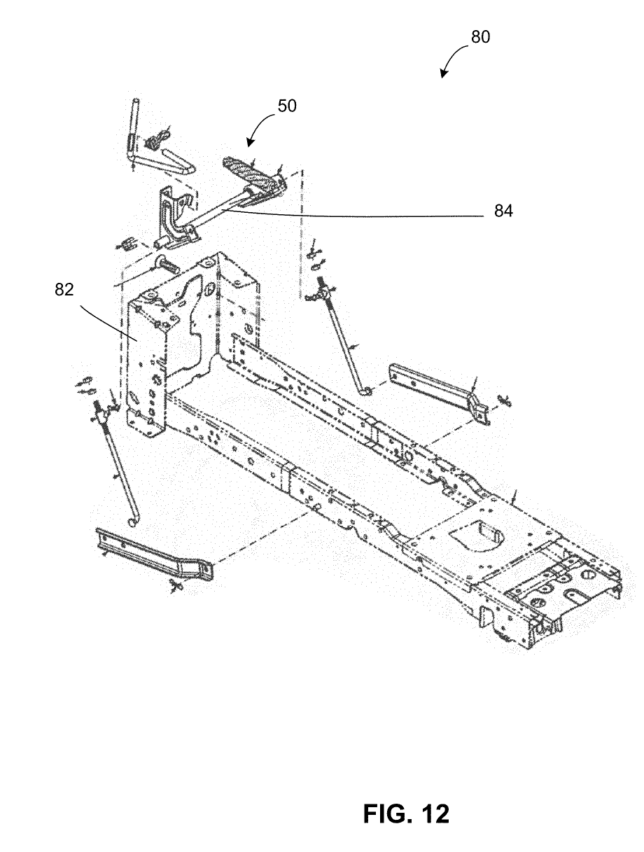

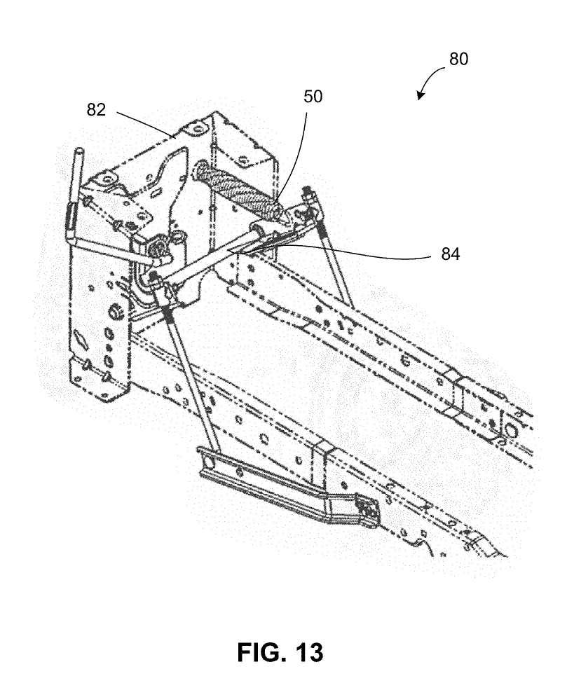

Referring now to FIG. 12 and FIG. 13, the spring tension assembly will be described in accordance with an exemplary application in which the spring tension assembly is configured as a lift-assist spring assembly to be coupled between a deck lift assembly (indicated generally by reference numeral 80) and a portion of the vehicle frame 82.

In the illustrated exemplary embodiment, the deck lift system 80 includes a lift-assist spring assembly 50 operatively coupled to a portion of the frame 82 and a portion of the deck lift system. The lift assist spring assembly 50 can be coupled to a lifting bar 84 to provide additional leverage for the cutting deck using force applied via the assisting spring. In other words, the lift assist spring assembly can be tensioned to provide a lifting force so that the user can provide a more limited amount of force when lifting the cutting deck (e.g., using a lever or pedal).

In a conventional system, the lift assist spring might be made up of the coiled spring body and hooks formed on each end, such that the person assembling the device might need to exert a large amount of force to stretch the lift assist spring between the mower frame and the lifting bar of the deck lift system.

The illustrated lift-assist spring assembly 50 can be installed by coupling the hook portion 60 to the lifting bar 84 of the deck lift system 80. The second end of the lift-assist spring 50 can be positioned adjacent a mounting opening in the frame portion 82. The fastener 62 can be introduced through an opening in the frame portion and into the female threaded portion defined by the second end 58 of the lift-assist spring. As the fastener 62 is rotated (e.g., using a suitable ratcheting tool or direct-driving tool) it is advanced into the threaded end of the spring, extending and tensioning the spring to create a biasing force to aid lifting the deck.

It will be appreciated that this configuration provides a mechanical advantage to a person assembling a deck lift mechanism, such that a higher amount of linear force (e.g., 100 pounds-200 pounds) does not have to be applied when assembling the mechanism. Rather, appropriate tools can be employed to rotate the fastener and thereby extend the lift-assist spring assembly to provide the desired amount of biasing force.

While the spring tension assembly has been described in connection with a deck lift assembly for a riding mower, it will be appreciated that the spring tension assembly can be used with other devices in which a tensioned spring is desired, without departing from the scope of the disclosed technology.

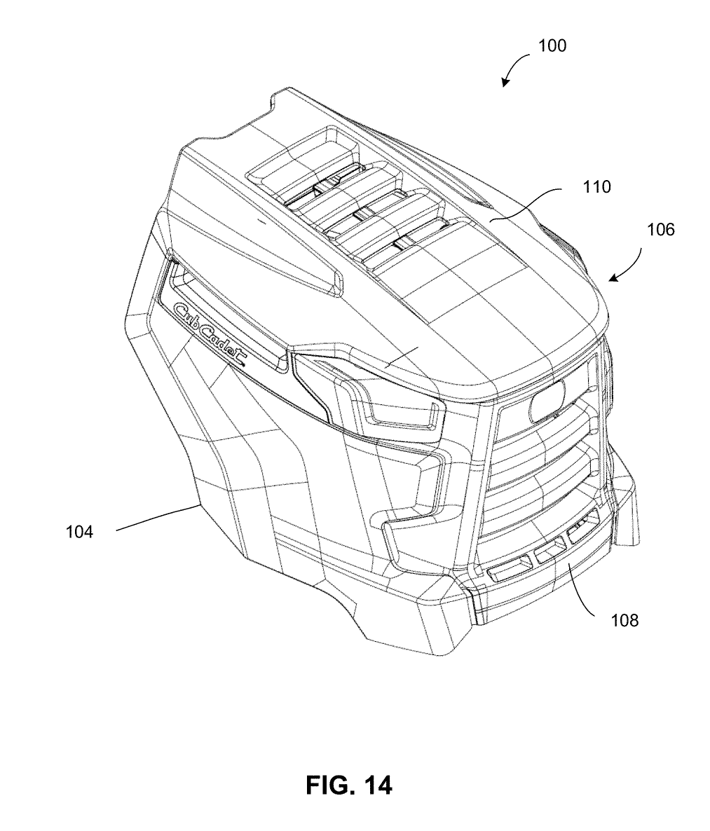

One aspect of the disclosed technology relates to a hood assembly 100 that includes a multi-piece assembly that can be snapped together or otherwise fastened together in a substantially tool-less manner (e.g., using only two threaded fasteners for the entire hood assembly). Exemplary embodiments of the hood assembly are illustrated in FIGS. 14-19.

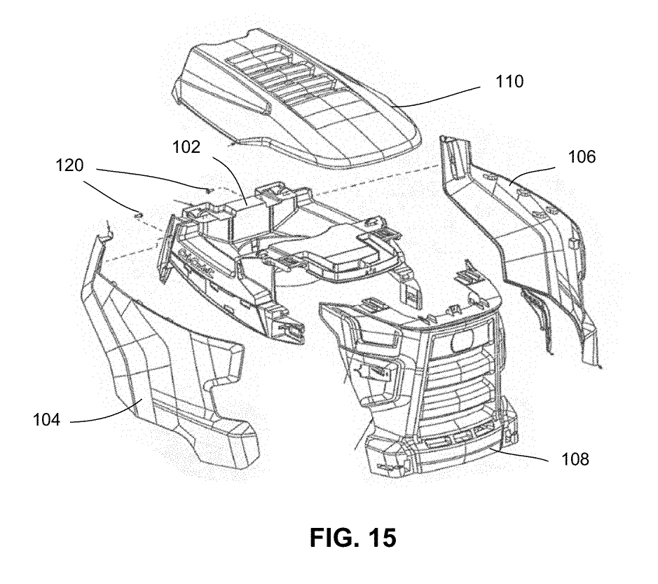

As shown in FIG. 15, an exemplary embodiment of the hood assembly 100 includes a hood frame portion 102 (also referred to simply as an upper portion), a pair of side portions 104 and 106, a grill portion 108 and a hood topper (also referred to as a top portion) 110. In a preferred embodiment, the hood assembly 100, including the frame portion 102, the side portions 104 and 106, the grill portion 108 and the top portion 110 are made of a plastic suitable for an outdoor power equipment application.

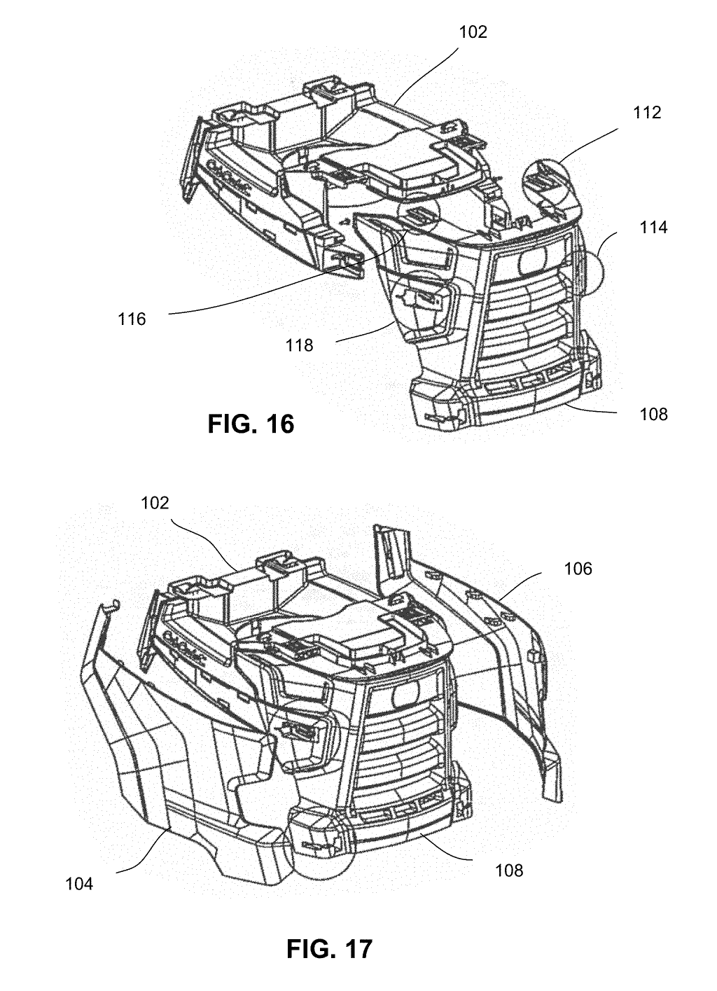

FIGS. 16-17 illustrate an exemplary method of assembling the hood assembly 100. As shown in FIG. 16, assembly of the hood can begin with positioning and aligning the frame portion 102 with the grill portion 108. As shown in FIG. 16, the frame portion 102 aligns at four locations with the grill portion 108 when assembling the two. The alignment and assembly locations are indicated with reference numerals 112, 114, 116 and 118. The frame portion 102 and the grill portion 108 are configured to include cooperative slide-lock elements to secure the grill portion 108 to the frame portion at the respective alignment and assembly locations 112, 114, 116 and 118.

As shown in FIG. 17, the side panels 104 and 106 can then be attached to the frame and grill assembly in a manner where the side panels hook into the front of the grill and slide/rotate into position to engage the grill and frame portion. FIG. 15 illustrates fasteners 120 that are used to fasten a rear portion of the side panels to the frame portion 102 for greater strength and stability. In accordance with one exemplary embodiment, the two fasteners 120 are the only two threaded fasteners (requiring tools) used in the hood assembly.

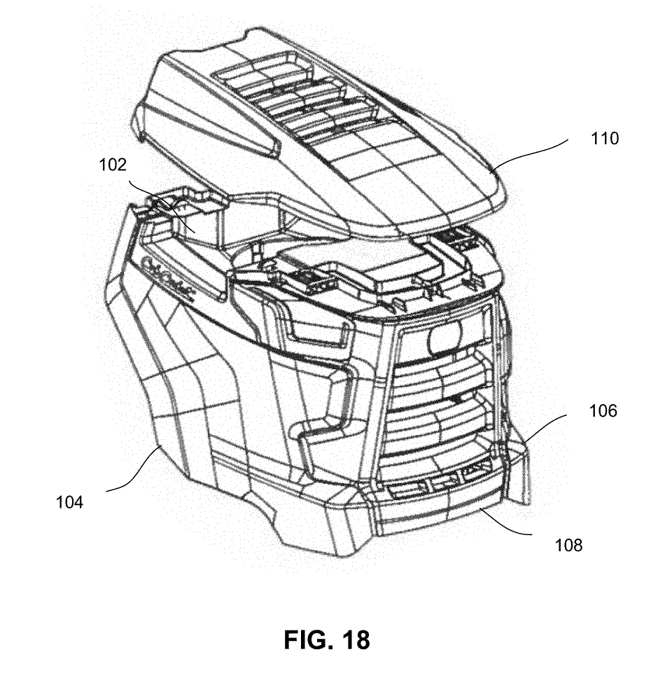

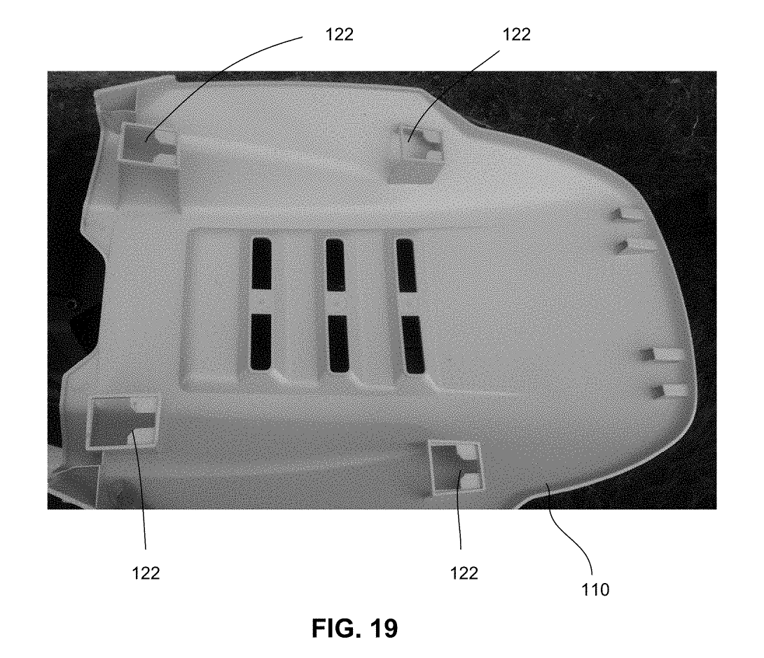

As shown in FIG. 18, once the side portions 104 and 106 are attached to the frame portion 102 and the grill portion 108, the top portion 110 can then be installed. The top portion 110 can be installed by aligning four locating features on the hood frame 102 with four complimentary receiving slots 122 formed on the underside of the top portion, and sliding the top portion 110 back into position thereby fastening the top portion 110 to the remainder of the hood assembly to complete assembly of the hood assembly 100. FIG. 19 provides an illustration of an exemplary embodiment of the top portion 110 of the hood including the receiving slots 122 that are configured to engage the engagement tabs on the hood frame.

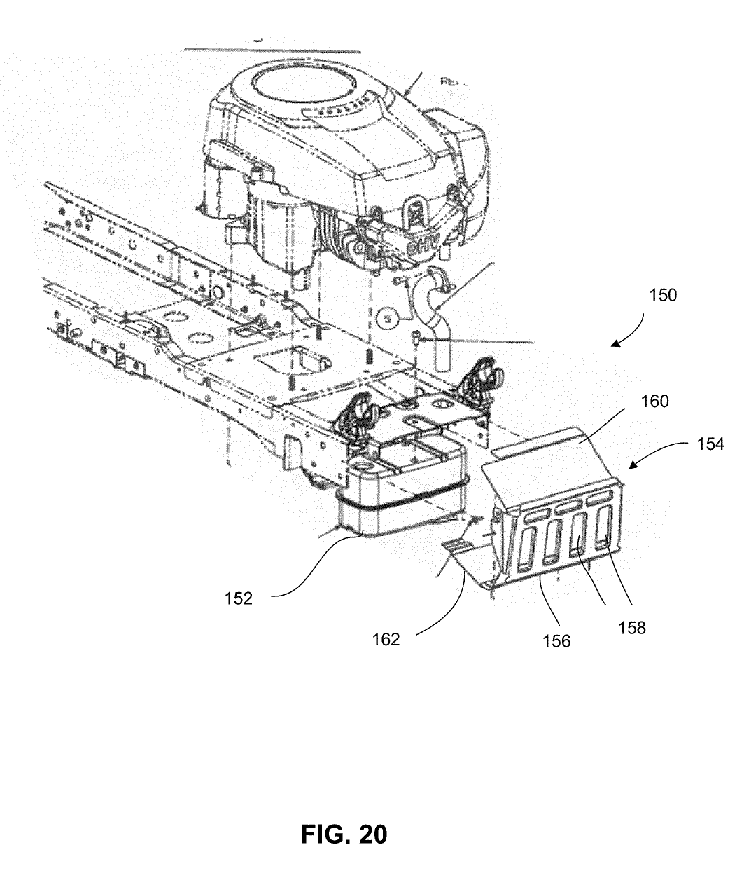

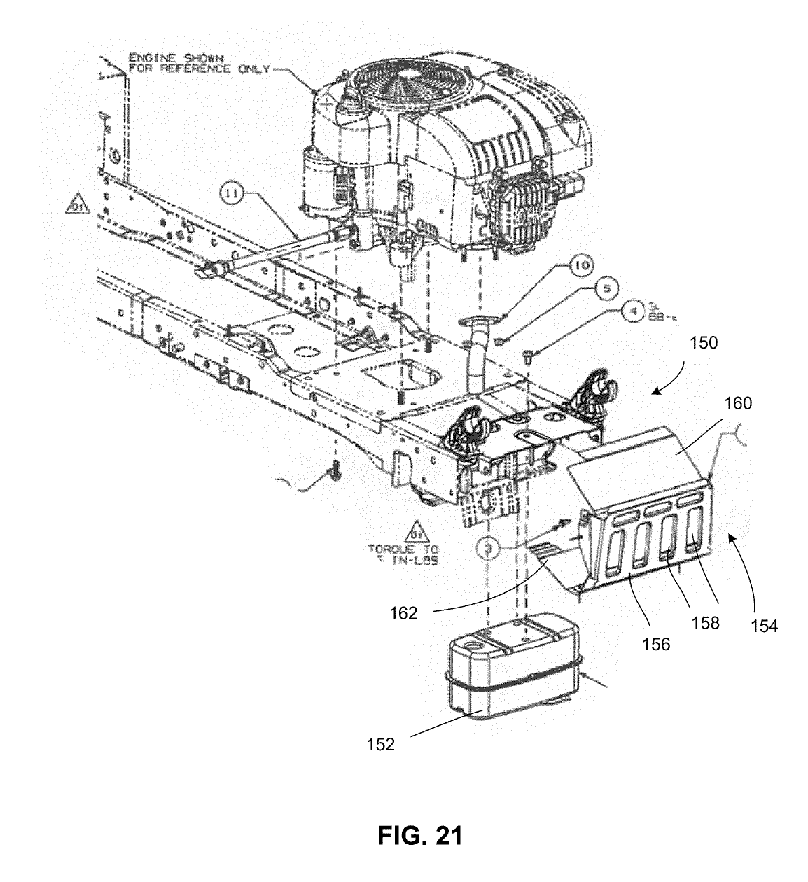

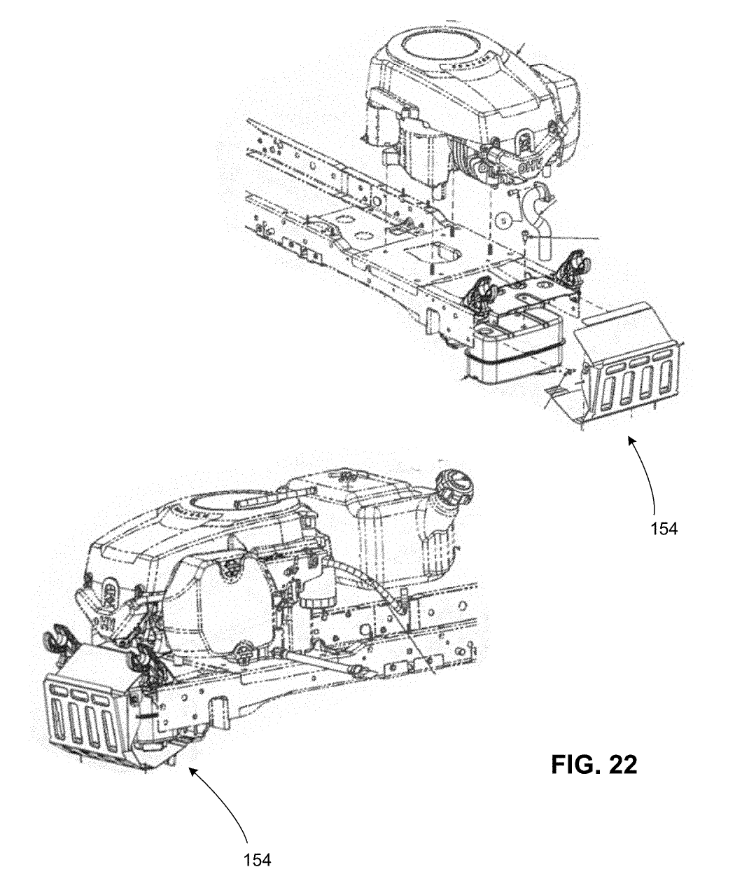

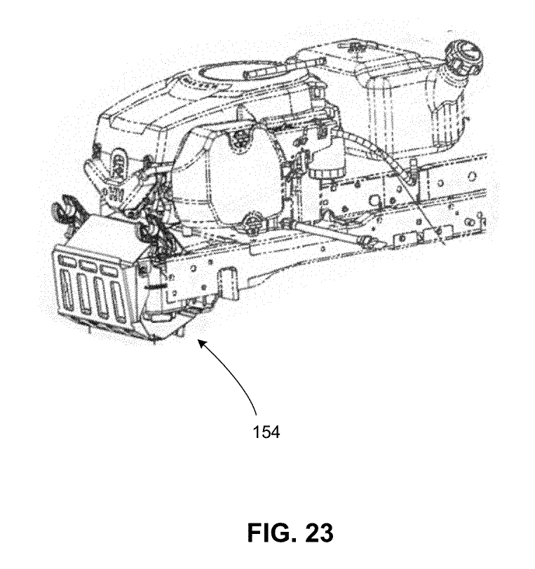

One aspect of the disclosed technology relates to a muffler assembly (also referred to as a dual-walled muffler assembly) 150. The muffler assembly 150 includes a muffler body 152 and a muffler shield assembly 154 operatively coupled to or otherwise positioned adjacent to the muffler body 152 such that a front portion (also referred to as a vent wall) 156 of the muffler shield assembly is spaced apart from a front portion of the muffler body 152. The muffler shield assembly 154 includes or otherwise defines a plurality of vent apertures 158. Exemplary embodiments are illustrated in FIGS. 20-23.

In accordance with the exemplary illustrated embodiment, the muffler shield assembly 154 is positioned adjacent the muffler body 152, and includes a first wall 160 positioned adjacent a first side of the muffler body and a second wall 162 positioned adjacent a second side of the muffler body. In the illustrated exemplary embodiment, the first wall 160 is an upper wall disposed above the muffler body 152 and the second wall 162 is a lower wall disposed below the muffler body 152. The upper wall 160 and the lower wall 162 are coupled by a vent wall 156 having or otherwise defining a plurality of vent openings 158.

The associated cooling system is configured to pull air from the top of the engine, down the front and between the two walls 160, 162 of the muffler shield assembly 154.

In accordance with one exemplary embodiment, the muffler assembly includes a muffler body and two shields. One of the two shields is a dual-purpose inner shield (also referred to as a top shield) that is configured to protect the carburetor from the heat associate with the pipes and protects the outer shield from the heat of the muffler. It is configured to direct air between the two shields.

In accordance with one or more of the described embodiments, the muffler is designed to keep the temperature under approximately eighty degrees Celsius (80° C.) adjacent the outer shell or shield.

One aspect of the disclosed technology relates to a seat suspension assembly. The seat suspension assembly includes a seat portion coupled to a body portion of the lawn care vehicle with a progressive (e.g., variable) rate spring assembly and an angled seat support.

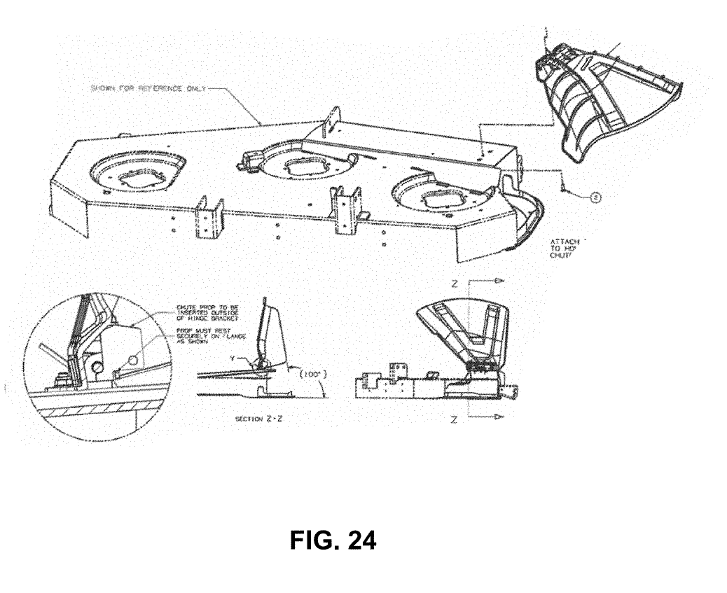

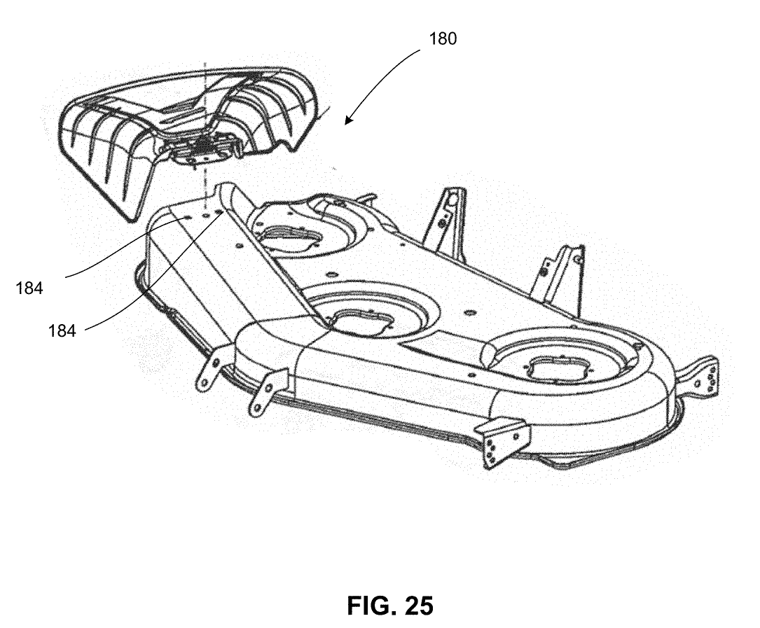

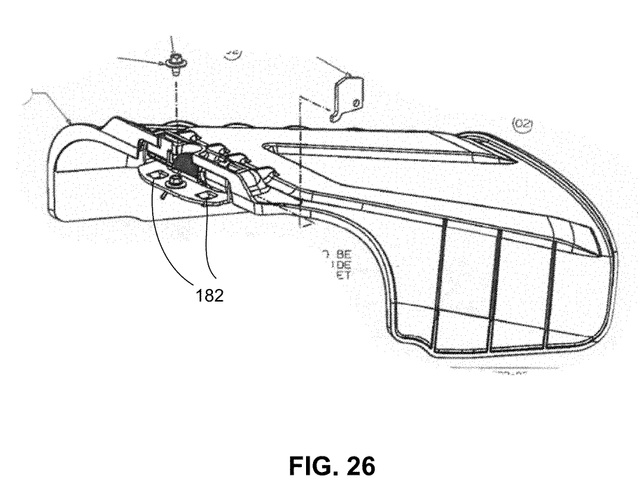

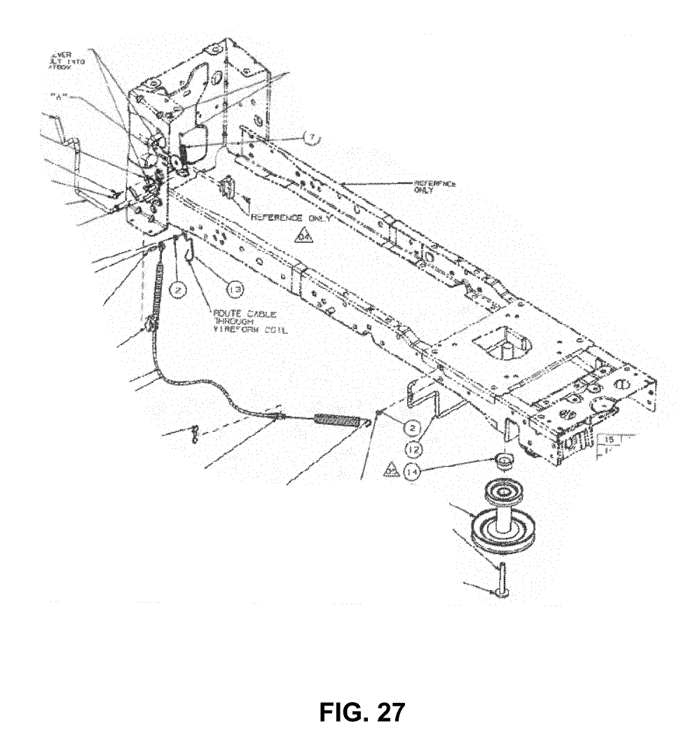

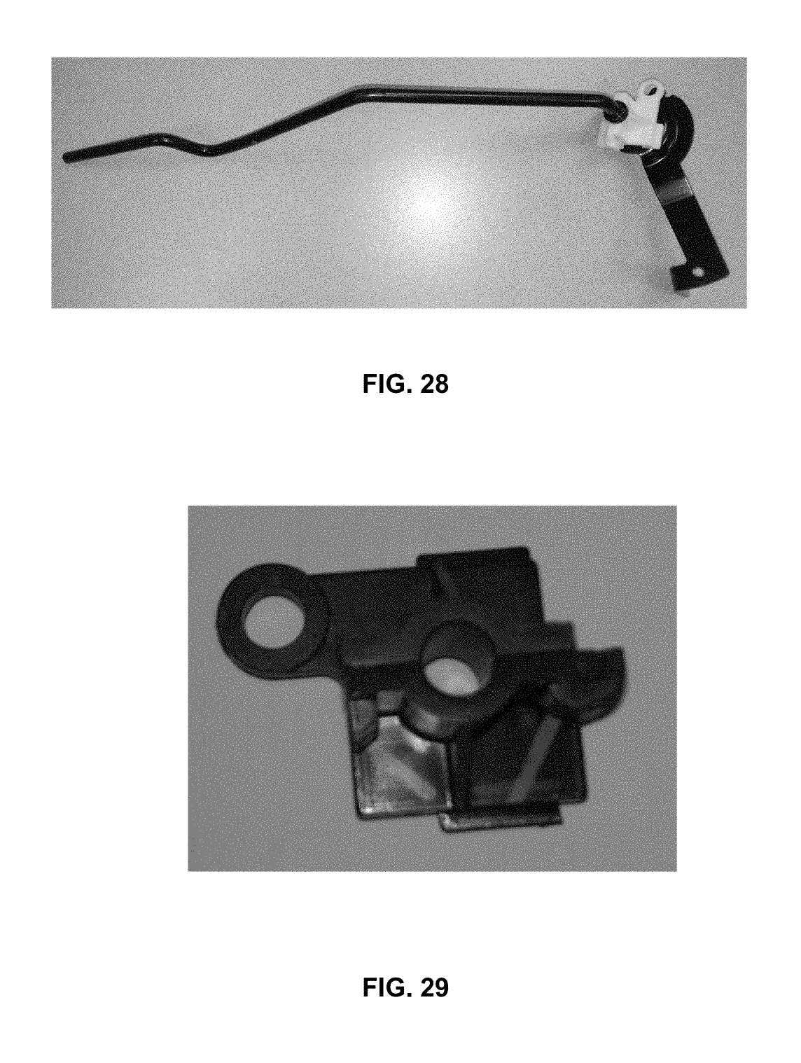

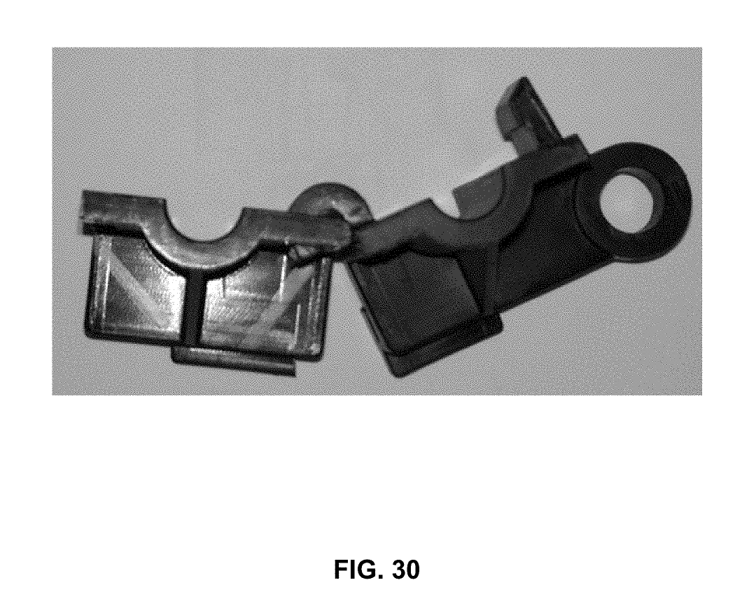

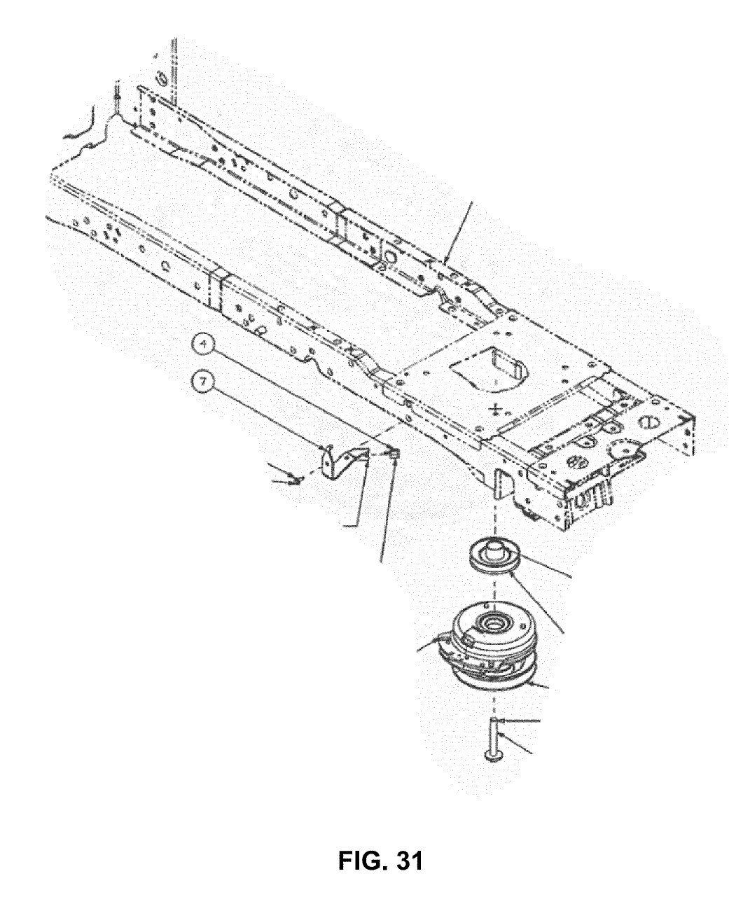

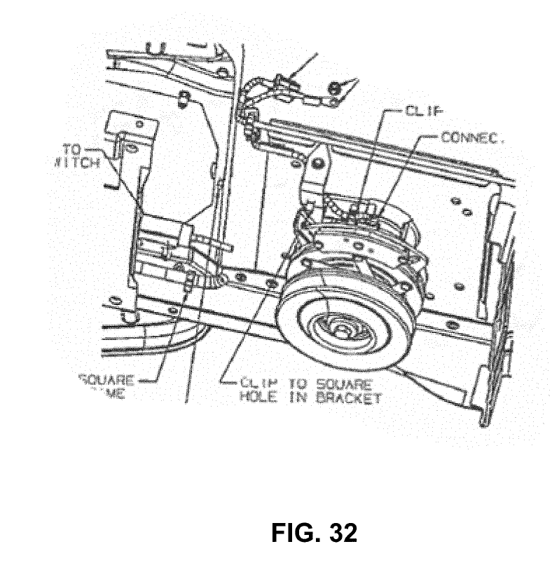

One aspect of the disclosed technology relates to a discharge chute attachment mechanism (indicated generally by reference numeral 180). The discharge chute attachment mechanism 180 includes a pair of tabs 182 (e.g., L-shaped tabs) configured to engage a pair of holes 184 (e.g., square holes). The tabs and holes are configured to prevent incorrect (e.g., backwards) installation of the discharge chute attachment. Exemplary embodiments are illustrated in FIGS. 24-26.

Although the disclosed technology has been shown and described with respect to a certain preferred aspect, embodiment or embodiments, it is obvious that equivalent alterations and modifications will occur to others skilled in the art upon the reading and understanding of this specification and the annexed drawings. In particular regard to the various functions performed by the above described elements (components, assemblies, devices, members, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary aspect, embodiment or embodiments of the disclosed technology. In addition, while a particular feature of the disclosed technology may have been described above with respect to only one or more of several illustrated aspects or embodiments, such feature may be combined with one or more other features of the other embodiments, as may be desired and advantageous for any given or particular application.

1. A spring tension assembly comprising:
a spring body having a plurality of coils along a longitudinal axis between a first end and a second end;
a first attachment mechanism coupled to or included with the first end; and
wherein the second end is configured to include a female threaded portion.

2. The spring tension assembly of claim 1, wherein a plurality of coils at the second end define a female threaded portion.

3. The spring tension assembly of claim 2, further comprising:
a threaded fastener configured to threadedly engage the female threaded portion of the second end.

4. The spring tension assembly of claim 2, wherein the spring body has a first diameter and the second end has a second diameter that is smaller than the first diameter.

5. The spring tension assembly of claim 2, wherein the spring body has a pitch that is equal to the pitch of the second end.

6. The spring tension assembly of claim 1, wherein the first attachment mechanism is a hook portion.

7. The spring tension assembly of claim 6, wherein the spring body is formed of coiled metal and the hook portion is integrally formed from the coiled metal.

8. The spring tension assembly of claim 3, wherein the second end defines a female threaded connection having a pitch, wherein the pitch matches the pitch of the threaded fastener.

9. A method of installing a tension spring, the method comprising:
positioning a spring tension assembly between two members to be coupled, the spring tension assembly including a spring body having a plurality of coils along a longitudinal axis between a first end and a second end, wherein a first attachment mechanism is coupled to or included with the first end, and wherein the second end is configured to include a female threaded portion;
coupling the first attachment mechanism to the first member to be coupled;
positioning the second end of the spring tension assembly proximate the second member to be coupled such that the second end of the spring tension assembly is proximate an aperture in the second member to be coupled;
introducing a male threaded member through the aperture in the second member and into the female threaded portion of the spring tension assembly; and
rotating the male threaded member in a direction that draws the second end of the spring body toward the second member and extends the spring to a desired tension.

10. A method of installing a deck lift assembly to couple a mower deck to an associated mower frame, the method comprising:
positioning a lift-assist tension spring assembly between two members to be coupled, the lift-assist tension spring assembly including a spring body having a plurality of coils along a longitudinal axis between with a first end and a second end, wherein a first attachment mechanism is coupled to or included with the first end, and wherein the second end is configured to include a female threaded portion;
connecting a first end of lift-assist tension spring assembly to a portion of the deck lift assembly;
positioning the second end of the spring body proximate to a portion of the mower frame such that the second end of the spring tension assembly is proximate an aperture in the mower frame;
introducing a threaded fastener through the aperture in the second member and into the female threaded portion of the spring tension assembly; and
rotating the threaded fastener in a first direction such that it extends the spring and places the spring under tension to provide a biasing force between the frame and the deck lift assembly.

11-22. (canceled)
